(19) United States
(12) Patent Application Publication
(10) Pub. No.: US 2008/0002405 A1
(43) Pub. Date: Jan. 3, 2008

(54) Crown jewels Xmas light display

(76) Inventor: Maryann Marasco, Red Bank, NJ (US)

Correspondence Address: Charles I. Brodsky, 2 Bucks Lane, Marlboro, NJ, 07746, US

(21) Appl. No.: 11/480,122

(22) Filed: Jul. 3, 2006

(51) Int. Cl. F21S 13/14

(52) U.S. Cl. 362/252

(57) ABSTRACT

A gemstone colored ornament illuminated from within by a light bulb electrically energized through serially connected tiers of pearl white illuminated light strings provides a hanging jewel appearance for display across the gable of a house.

### CROSS-REFERENCE TO RELATED APPLICATIONS

None.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

1. Field of the Invention

This invention relates to the outdoor lighting of a house, in general, and to the Christmastime light display at the outside of a house, in particular.

2. Description of the Related Art

As is well known and understood, Christmas decorations are often hung at the outside of a house from right after Thanksgiving through New Year's Day. Many of these decorations, furthermore, are illuminated at night.

### SUMMARY OF THE INVENTION

As will become clear from the following description, the present invention is a unique construction of a Christmastime light display which gives a jeweled appearance across the gables of a house. More particularly, it provides the look of a gemstone hanging from the strands of a pearl necklace. As will be appreciated, calling the invention the “Crown Jewels” is quite appropriate.

As will become clear, the crown jewel Xmas light display includes first and second strings of serially connected illuminated lights of prescribed wattage, an illuminated light of greater wattage serially connected between the first and second strings, and a plurality of fasteners along at least the lengths of the strings for securing the strings and the illuminated light to the gable of a house. Whereas the fasteners may be located only at the ends of each string, in a preferred embodiment they are also located at the greater wattage light. To give the “Crown Jewel” effect, the greater wattage light includes a gemstone colored ornament illuminated from within (to glow one of red, green, blue, purple and white) by a light bulb electrically energized by a pair of electrical power lines coupled with the ornament, and wherein the strings of illuminated lights include a plurality of ornaments illuminated from within (to glow white or pearl white) by light bulbs electrically energized from the same pair of electrical power lines. To fasten the display to the gables of the house, a series of clip rings may be employed to couple the ends of each string and the greater wattage light at appropriate points.

In a preferred construction of the invention, each of the first and second strings include at least one tier or strand of serially connected lights, with each successive tier below a first including an increased number of lights. In one construction of the invention, three such tiers or strands are employed, with each successive tier being composed of two more lights than the tier or strand immediately above it—12, 14, 16, for example, from top to bottom. With 12 individual white or pearl white glowing ornaments of a string being of a 3 inch diameter, for example, of 2 inch separation, a necklace effect of some 5 feet is presented on either side of the greater wattage ornamentation—which itself could be sized 3 feet from top to bottom and 2 feet from side to side, and colored one of red, green, blue, purple and white to present the appearance of a ruby, emerald, amethyst, diamond, etc. As will also be seen, additional strings of tiers or strands could be serially coupled at the end of a first string remote from the greater wattage ornament, to provide extended lengths of these strings.

### BRIEF DESCRIPTION OF THE DRAWINGS

These and other features of the present invention will be more clearly understood from a consideration of the following description, taken in connection with the accompanying drawings, in which:

FIG. 1 is an illustration of the gemstone colored light ornamentation of the invention;

FIG. 2 depicts the hanging of the gemstone colored light ornamentation of FIG. 1 on one side with three strings of illuminated lights of lesser wattage arranged in three tiers or strands each;

FIG. 3 is an illustration as to a manner of fastening the gemstone colored light ornamentation and strings of illuminated lights at the gable of a house; and

FIG. 4 is an illustration of the gemstone colored light ornamentation serially connected with three strings of illuminated lights of three tiers or strands on each side of the gemstone colored light ornamentation.

### DETAILED DESCRIPTION OF THE INVENTION

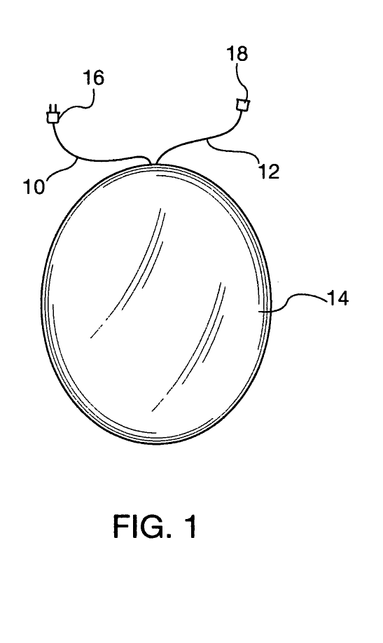

In FIG. 1, an illuminated light energized by a pair of electrical power lines 10, 12 sits behind a gemstone colored ornament 14 to glow, for example, one of red, green, blue, purple and white when the light bulb is energized. A male plug is shown at 16, and a female plug is shown at 18.

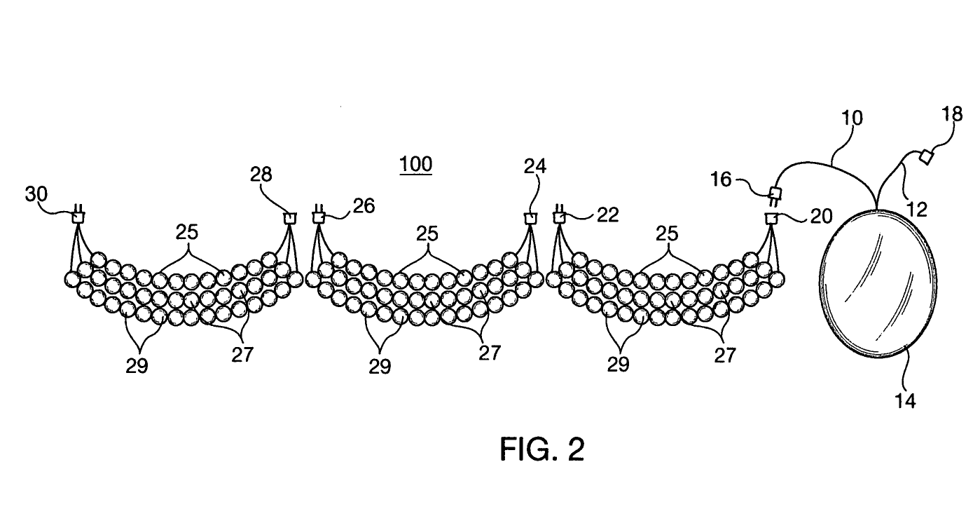

In FIG. 2, a first string of serially connected illuminated lights 100 are shown, of prescribed wattage, less than that of the bulb behind the gemstone ornament 14. As indicated, the serial connection is established by the right most female plug 20 coupling with the male plug 16, together with its male and female plugs 22, 24 connecting together, with its male plug 26 connecting with its female plug 28, and with its male plug 30 connecting to the electrical supply line as shown. In accordance with the invention, the lesser wattage lights 25 may each be of a type to glow “white” when illuminated, and beyond its own plastic covering composed to produce a “pearl white” glow when the bulb is illuminated. In a preferred embodiment of the invention, the string 100 is composed of three strands or tiers of such lights 25, all serially connected, with a first tier, as illustrated, including 12 illuminable lights, a second lower included tier including 14 illuminable lights, and a third still lower included tier including 16 illuminable lights—more specifically, with each successive tier below the first including an increased number of illuminable lights. The illuminable lights of the intermediate tier in FIG. 2 are indicated at 27, and at 29 in the lowest tier of FIG. 2.

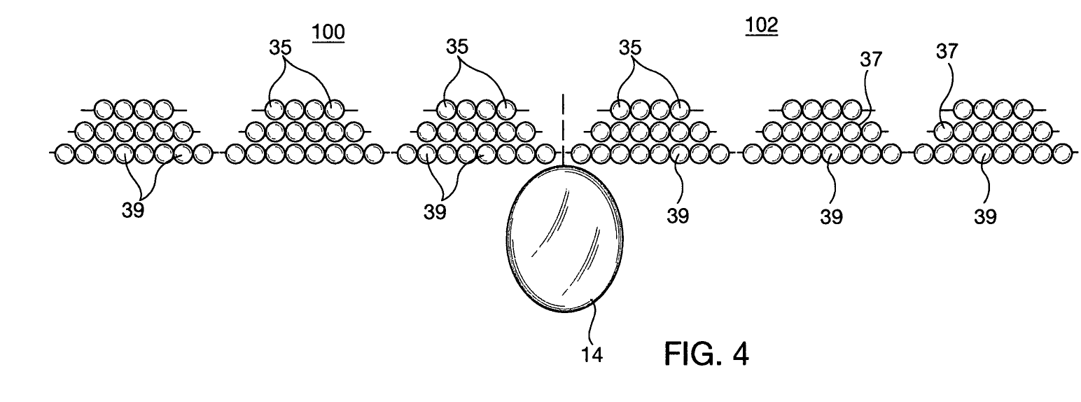

FIG. 4 shows the gemstone colored ornament 14 hung between first and second strings of these lesser wattage lights, arranged in three tiers on each side of the ornament 14. The first tier 35 illustrates (in this simplified drawing) four such lights, the middle tier 37 includes 6 such lights, and the lower tier 39 shows 8 such lights. As will be understood, each light of the string is serially connected with its adjacent light, and with the central gemstone greater wattage light in the center.

With the preferred construction having the gemstone ornament glowing one of red, green, blue, purple and white to simulate such colors as ruby red, emerald green, sapphire blue, amethyst purple and diamond, and with the lesser wattage lights of the strings 100 (and 102 in FIG. 4), a “Crown Jewels” appearance is presented when the strings 100 and 102, and the gemstone colored ornament 14 are hung from the gables of a house.

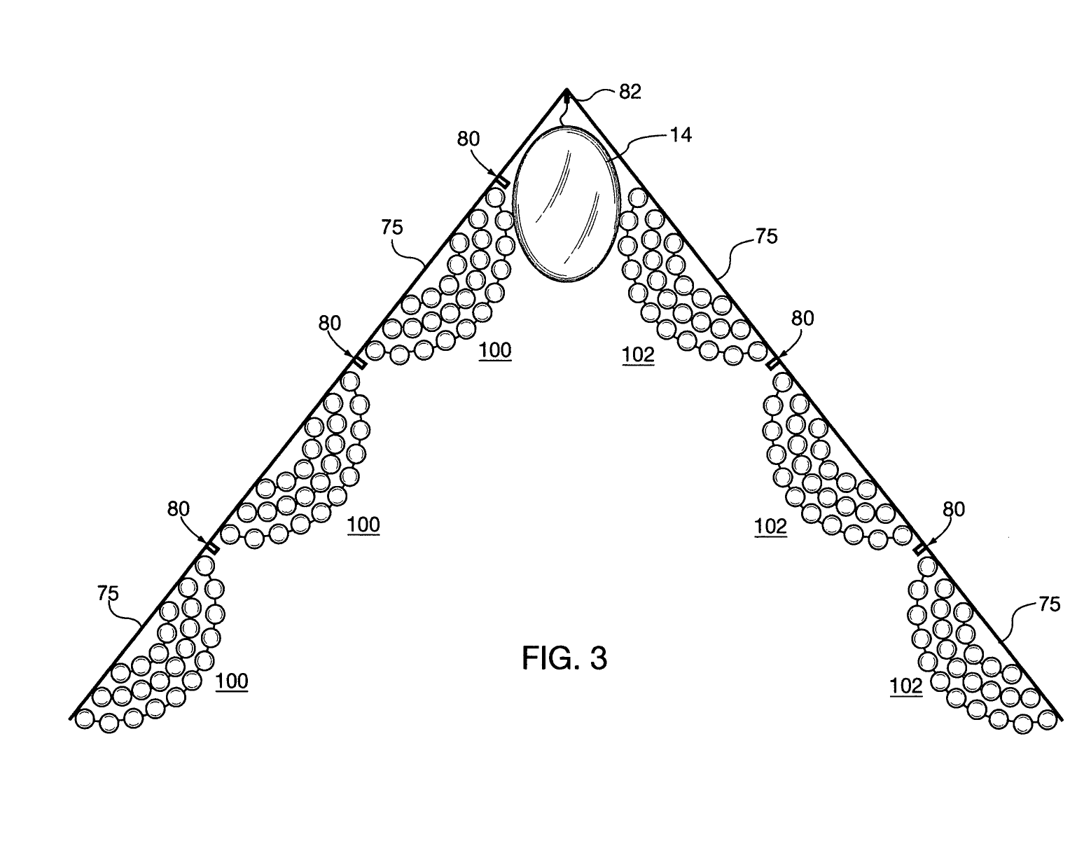

Such hanging of the “Crown Jewels” is shown in FIG. 3, with the gables of the house being shown at 75. (For purposes of simplification, the electrical wire interconnections between the individual lesser illuminated lights as 25, 27, 29 are omitted, as are the electrical connections between the strings 100 and 102 with the gemstone colored greater wattage gemstone light 14.) A plurality of fasteners along at least the length of the strings 100, 102 connect to the gable 75 for securing the strings and their illuminated lights to the house. Shown as clip rings 80 located at the ends of each string, and with a further clip ring 82 for securing the gemstone colored greater wattage light ornament 14, the overall jeweled effect is presented. As will be understood by those skilled in the art, the plugs at the end of the strings 100, 102 join to the electrical supply to energize the entire, serially connected string and intermediate gemstone configuration.

In one particularly attractive display of the invention, the gemstone colored ornament of FIGURE was selected of a top-to-bottom length of 3 feet, and side-to-side width of 2 feet. The light ornaments of the first and second strings 100, 102 in such construction were selected of a 3 inch diameter with a 2 inch spacing between successive lights. With the end most light of each string 100, 102 being 1 inch from its fastener, individual 5 foot lengths of string serially connect to each side of the 2 foot wide gemstone ornament 14. With the configuration of FIG. 4, 9 clip ring fasteners are utilized, 4 on each gable, and 1 at the peak. Clip rings of ¾ inch opening the hanging of the light display to the house gables. As will be appreciated, to keep costs reasonably low, each of the lights are enclosed within their own plastic ornamental covering.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the scope of the invention.

I claim:

1. A light display comprising:
first and second strings of serially connected illuminated lights of prescribed wattage;
an illuminated light of greater wattage serially connected between said first and second strings; and
a plurality of fasteners along at least the lengths of said strings for securing said strings and said illuminated light to the gable of a house.

2. The light display of claim 1 wherein said fasteners are located at the ends of each string.

3. The light display of claim 1 wherein said fasteners are located at the ends of each string and at said greater wattage light.

4. The light display of claim 1 wherein said greater wattage light includes a gemstone colored ornament illuminated from within by a light bulb electrically energized by a pair of electrical power lines coupled with said ornament.

5. The light display of claim 4 wherein said gemstone colored ornament glows one of red, green, blue, purple and white when said light bulb is energized.

6. The light display of claim 1 wherein each of said first and second strings include a plurality of ornaments illuminated from within by light bulbs electrically energized by a pair of electrical power lines coupled with said strings.

7. The light display of claim 1 wherein said greater wattage light includes a gemstone colored ornament illuminated from within by a light bulb electrically energized by a pair of electrical power lines coupled with said ornament, wherein said gemstone colored ornament glows one of red, green, blue, purple and white when said light bulb is energized, and wherein each of said first and second strings include a plurality of ornaments illuminated from within by light bulbs electrically energized by said pair of electrical power lines.

8. The light display of claim 7 wherein said ornaments of said first and second strings glow white when said light bulbs of said string are energized.

9. The light display of claim 3 wherein said plurality of fasteners include a series of clip rings coupling said ends of each string and said greater wattage light to the gable of the house.

10. The light display of claim 1 wherein each of said first and second strings include at least one tier of serially connected illuminable lights, with each successive tier below a first tier including an increased number of illuminable lights.

11. The light display of claim 10 wherein said first tier includes 12 illuminable lights, a second lower included tier includes 14 illuminable lights, and a third still lower included tier includes 16 illuminable lights.

12. The light display of claim 11 wherein said greater wattage light includes a gemstone colored ornament illuminated from within by a light bulb electrically energized by a pair of electrical power lines coupled with said ornament, wherein said gemstone colored ornament glows one of red, green, blue, purple and white when said light bulb is energized, and wherein each of said first and second strings include a plurality of ornaments illuminated from within by light bulbs electrically energized by said pair of electrical power lines.

13. The light display of claim 12 wherein said ornaments of said first and second strings glow white when said light bulbs of said strings are energized.

14. The light display of claim 13 wherein said plurality of fasteners include a series of clip rings coupling said ends of each string and said greater wattage light to the gable of the house.

15. The light display of claim 12 wherein said ornaments of said first and second strings glow pearl white when said light bulbs of said strings are energized.

16. The light display of claim 15 wherein said ornaments of said first and second strings are each of 3 inch diameter with a 2 inch spacing therebetween.

17. The light display of claim 16 wherein said gemstone colored ornament of said greater wattage light is of a length of 3 feet and a width of 2 feet.

18. The light display of claim 17 wherein each of said plurality of ornaments of said first and second strings, and said gemstone colored ornament of said greater wattage light, are composed of plastic.
